(19) United States
(12) Patent Application Publication
(10) Pub. No.: US 2006/0093711 A1
(43) Pub. Date: May 4, 2006

(54) Food wrapper and method of handling food

(76) Inventors: Jerome Bialick, Guttenberg, NJ (US); Thomas I. Nadler, West Orange, NJ (US); Michael Anthony Treanor, North Babylon, NY (US)

Correspondence Address: Kirschstein, Ottinger, Israel & Schiffmiller, P.C., 489 Fifth Avenue, New York, NY, 10017-6105, US

(21) Appl. No.: 10/979,897

(22) Filed: Nov. 1, 2004

(51) Int. Cl. B65D 81/32; A21D 10/02

(52) U.S. Cl. 426/115

(57) ABSTRACT

A food wrapper protects food wrapped therein, enables the food to be efficiently exposed for consumption, and collects food juices to resist drips and leaks therefrom.

### BACKGROUND OF THE INVENTION

1. Field of the Invention

The present invention generally relates to the handling of foods and, more particularly, to the wrapping of foods for sale to and consumption by consumers.

2. Description of the Related Art

Many food establishments wrap and package foods for immediate or later sale to consumers in a variety of packaging materials, including paper or foil wraps, paperboard boxes and cartons, and Styrofoam™ containers. The boxes, cartons and containers are bulky and occupy significant storage space. The paper and foil wraps are less bulky and more economical, but are not altogether desirable because they tend to self-open, do not effectively prevent drips from food juices from escaping therefrom, and must be unwrapped by repeated tearing or peeling of the wraps to enable the consumer holding the wrapped food to expose the food for eating.

For example, a sandwich typically includes two or more slices of bread, or halves of a bun, with a filling, such as meat, cheese, tuna fish and like foodstuffs, placed between them. The sandwich is typically garnished with condiments, such as relish, mustard, catsup and the like, together with garnish slices of other foodstuffs, such as tomatoes and lettuce leaves. When holding such a sandwich in one's hand and biting into the sandwich, juices from the foodstuffs flow therefrom and, especially in the case of paper and foil wrapped sandwiches, inevitably drip and leak from such packaging materials onto the consumer and onto his or her clothing. Consumers eating such wrapped sandwiches inevitably hold the sandwiches far from their clothing and at awkward angles to avoid staining their clothing.

Examples of sandwich wrappers depicting the prior art can be found by reference to U.S. Pat. No. 4,795,648; U.S. Pat. No. 5,580,625; U.S. Pat. No. 5,955,133 and Reissue Pat. No. 35,241.

### SUMMARY OF THE INVENTION

### OBJECTS OF THE INVENTION

Accordingly, it is a general object of this invention to facilitate the speed and efficiency with which foods are wrapped for later sale to and consumption by consumers.

More particularly, it is an object of the present invention to resist drips and leaks from wrapped foods, especially during eating the foods.

Still another object of the present invention is to rapidly expose a wrapped food to facilitate its eating in a sanitary manner.

### FEATURES OF THE INVENTION

In keeping with the above objects and others which will become apparent hereinafter, one feature of the present invention resides, briefly stated, in a food wrapper and a method of handling food, which comprise outer and inner layers of sheet material overlapping each other and bounding a compartment into which a food, such as a sandwich, is inserted in an unwrapped state of the layers. The layers are wrappable, for example, by being rolled about a rolling axis, to a wrapped state in which the layers form an envelope surrounding the food. A weakened zone, such as a score line, is formed in the layers and divides the envelope into envelope portions, for example, upper and lower envelope portions. One of the portions, for example, the upper portion is removable from the other of the portions, i.e., the lower portion, along the weakened zone to expose the food in the wrapped state within the lower portion. A seal is provided for sealing the layers in the lower portion to resist food escape, e.g., leaks and drips, therefrom.

The removed upper portion, which contains no food, can be discarded. In a modification, the food is cut into two food portions prior to their insertion into the compartment. The layers are wrapped about the two food portions as described above. However, when removing the upper portion of the envelope, the food portion therein is also removed. The result is two exposed food portions, each wrapped in its own sealed envelope portion.

In the preferred embodiment, the outer and inner layers are discrete sheet materials. The outer layer is preferably paper. The inner layer is preferably a plastic film either fabricated as a flat sheet, or extruded as a tube. The outer and inner layers could be made of the same sheet material, such as an extruded plastic tube, which is flattened to form the overlapping layers in the unwrapped state.

The rolling of the layers is a rapid and efficient packaging technique, especially suitable for fast food establishments. Drips and leaks are effectively resisted by the seal. To expose the food within the wrapper, the consumer need only rapidly pull the upper envelope portion away from the lower envelope portion in a single decisive manual stroke, thereby rupturing the envelope along the weakened zone, which advantageously is a series of perforations or scores formed in the layers.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a top plan view of a sandwich inserted within a food wrapper in an unwrapped state according to this invention;

FIG. 2 is an enlarged sectional view taken on line 2-2 of FIG. 1;

FIG. 3 is a perspective view of the sandwich being wrapped;

FIG. 4 is a perspective view of the wrapped sandwich; and

FIG. 5 is an exploded view of the exposed sandwich ready for consumption.

### DETAILED DESCRIPTION OF THE PREFERRED EMBODIMENTS

Reference numeral 10 in the drawings identifies a food wrapper having an outer layer 12 of generally rectangular shape and preferably sized about fifteen inches long by fourteen inches wide. The outer layer 12 is preferably constituted of a natural or bleached paper material and may have a gloss coating 14 thereon. The outer layer 12 has opposite sides or ends 16, 18.

The wrapper 10 also has a liner or inner layer 20, also of generally rectangular shape and preferably sized about fifteen inches long by about thirteen inches wide. The inner layer 20 is preferably constituted of a liquid-resistant, high density polyethylene plastic film, or of wax paper. The inner layer 20 has opposite sides or end regions 22, 24.

The inner layer 20 need not be a discrete flat sheet, but can also be an extruded tube which, when flattened, assumes the above dimensions. Also, the inner and outer layers need not be separate sheets of different materials, but can together constitute the flattened portions of a tube, preferably constituted of a plastic film.

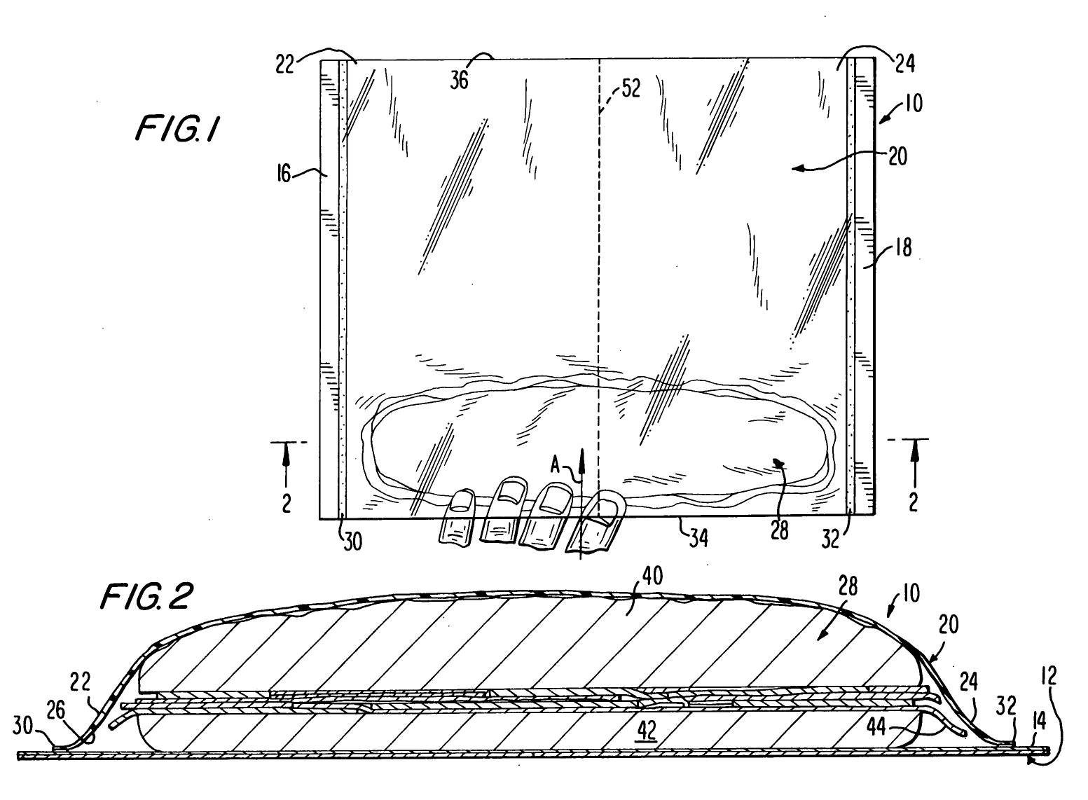

The layers 12, 20 overlap each other and, as best seen in FIG. 2, together bound a compartment 26 in which a food, such as illustrated sandwich 28, is received in an unwrapped state depicted in FIG. 2. When the layers 12, 20 are separate sheets, they are sealed together at some of their peripheral margins. For example, a heat-fused seal, or a food-grade adhesive 30 seals the end region 22 and the end 16, thereby sealing the left peripheral margin in FIG. 1. Also, it is preferred that another heat-fused seal, or another food-grade adhesive 32 seals the end region 24 and the end 18, thereby sealing the right peripheral margin in FIG. 1. The other peripheral margins 34, 36 are preferably left unsealed so that the inner layer 20 can be lifted up from the outer layer 12 at either of these other unsealed margins 34, 36, thereby enabling access of the sandwich 28 to the compartment 26 from either unsealed margin 34, 36. Of course, it is only necessary to have one margin 34, 36 left unsealed, and the other margin 36, 34 can be sealed, again either by a heat-fused seal or a food-grade adhesive.

The sandwich 28 itself is conventional and typically comprises two slices of bread, or halves 40, 42 of a bun or a loaf, with a filling 44 therebetween. Many variations of sandwiches are contemplated by this invention, including an open-faced sandwich having one piece of bread or bread product with a topping, canape or finger sandwiches, multidecker or club-type sandwiches, all of which generally include a spread and a garnish. Other types of sandwiches for use with this invention include ice cream sandwiches, wraps, and pocket-type sandwiches, such as tacos, burritos, falafel pita pockets and the like. Furthermore, this invention is not intended to be limited to sandwiches since other foods could likewise be advantageously wrapped with the food wrapper 10. All of these foods share, at least to some extent, the problem of juices flowing therefrom, especially during consumption of the foods, and dripping onto the consumer or onto his or her clothing. When such foods are held in one's hand during eating, such drips are messy and often leads to one's clothing being stained.

In accordance with this invention, the food wrapper 10 enables foods to be wrapped quickly and efficiently for later sale to and consumption by the consumer. The food wrapper 10 effectively resists such drips therefrom. The food wrapper 10 enables a wrapped food to be rapidly exposed and eaten in a sanitary manner.

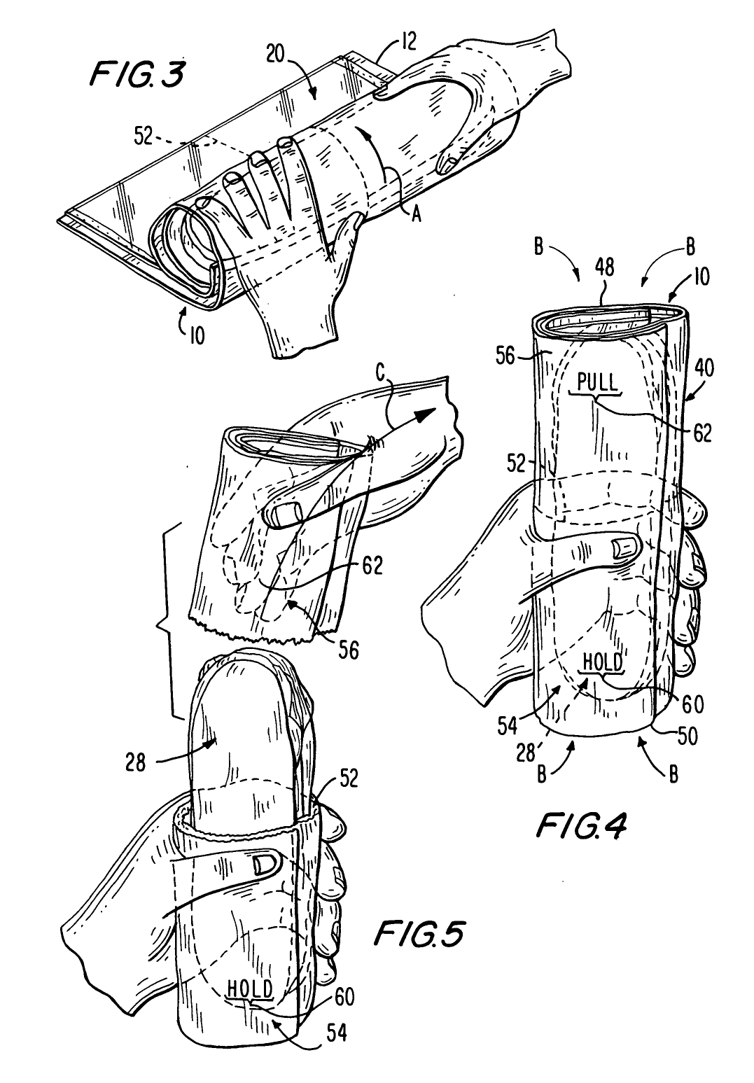

Returning to FIG. 1, the sandwich 28 is placed into the compartment 26 by lifting the inner layer 20 up from the outer layer 12 at the unsealed margin 34, and allowing the inner layer 20 to fall down onto the sandwich 28. Thereupon, the layers 12, 20 are rolled together around the sandwich 28 in the direction of arrow A in FIGS. 1 and 3, thereby forming a generally cylindrical envelope 46 surrounding the sandwich 28, as best seen in FIG. 4. In this wrapped state, the sandwich is wrapped for sale to the customer. The upper 48 and lower 50 ends of the cylindrical envelope in FIG. 4 may be tucked into the open axial ends of the envelope in the direction of arrows B to prevent the same from unrolling and unraveling.

A weakened zone 52, preferably constituted by a score line, is formed in the layers 12, 20, preferably linearly along a centerline of the layers. The score line is essentially a series of overlapping cuts in both layers which weakens the structural integrity of the layers in the zone.

When the consumer wishes to consume the wrapped sandwich, the consumer, as shown in FIG. 4, holds a lower portion 54 of the envelope in one hand, that is, the portion of the envelope below the weakened zone 52, tightly against the sandwich. Thereupon, the consumer grasps an upper portion 56 of the envelope with the other hand, that is, the portion of the envelope above the weakened zone 52, loosely against the sandwich. With a rapid motion, the consumer jerks the upper portion 56 upwardly away from the lower portion 54 in the direction of arrow C, thereby rupturing the envelope along the weakened zone 52. An upper end of the sandwich is now exposed for consumption by the consumer. The upper portion 56 can be discarded.

During consumption, drips and leaks from the sandwich are prevented by fluid-tight seals, such as the seal 30 or the seal 32, one of which is located at the bottom of the envelope. Food juices likewise cannot escape through the sides of the envelope because of the presence of the circumferential rolled-up wall of the inner layer. It is further noted that the consumer's hands never touch the sandwich during eating, thereby promoting sanitary eating conditions. When the inner layer is a tube, rather than a sealed sheet, it is the circumferentially complete side wall of the tube which acts as the seal to resist fluid escape. Essentially, the inner layer, whether sealed to the outer layer or formed as a tube, serves as a bag in which to collect fluids from the food.

In a variant, the sandwich 28 is cut in half prior to placement in the compartment 26 and is wrapped as before. This time, rather than having the consumer loosely grip the upper portion 56 against the sandwich, the consumer tightly grips the upper envelope portion 56 against an upper half of the cut sandwich. The upper envelope portion 56, together with the upper sandwich half, are jerked away from the lower envelope portion 54 together with its lower sandwich half, thereby rupturing the weakened zone 52. Now, both sandwich halves, each wrapped in respective envelope portions, are ready for sanitary consumption. Drips and leaks are prevented by the fluid-tight seals 30, 32, one of which is located at the bottom of each envelope portion.

The exterior surface of the outer layer 12 may be printed with graphics including pictorial and written representations, especially operating instructions 60, 62 advising the consumer to “hold” the lower portion 54 and to “pull” the upper portion 56. Advertising and logo information could also be printed on the outer layer.

It will be understood that each of the elements described above, or two or more together, also may find a useful application in other types of constructions differing from the types described above.

For example, the wrapper need not be rolled around the sandwich, but could also be folded in one or more folds having linear folded seams to form an envelope which is a flattened tube.

While the invention has been illustrated and described as embodied in a food wrapper and method of handling food, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A food wrapper, comprising:
a) an outer layer of sheet material;
b) an inner layer of sheet material overlapping, and bounding with, the outer layer a compartment, the layers being wrappable from an unwrapped state in which a food is inserted into the compartment, to a wrapped state in which the layers form an envelope surrounding the food;
c) a weakened zone in the layers and dividing the envelope into envelope portions, one of the envelope portions being removable from the other of the envelope portions along the weakened zone to expose the food in the wrapped state; and
d) a seal for sealing the layers in the other of the envelope portions to resist food escape therefrom.

2. The wrapper of claim 1, wherein the outer and inner layers are discrete sheet materials laminated together at the seal.

3. The wrapper of claim 1, wherein the layers are wrappable by being rolled about a rolling axis, and wherein the seal and the weakened zone respectively extend along the layers in the unwrapped state along respective directions perpendicular to the rolling axis.

4. The wrapper of claim 3, wherein the weakened zone is a score extending along a line.

5. The wrapper of claim 3, wherein the seal is an adhesive extending along a line.

6. The wrapper of claim 1, wherein the outer layer has opposite ends, and wherein the inner layer has opposite end regions, and wherein the seal extends between one of the ends of the outer layer and one of the opposite end regions of the inner layer.

7. The wrapper of claim 6, and a further seal for sealing the layers together in the one envelope portion, the further seal extending between the other of the ends of the outer layer and the other of the opposite end regions of the inner layer.

8. The wrapper of claim 7, and wherein the weakened zone is a score extending along a line intermediate the seals.

9. The wrapper of claim 3, wherein the compartment has at least one open axial end region in the unwrapped state.

10. The wrapper of claim 1, wherein the sheet material of the outer layer is paper, and wherein the sheet material of the inner layer is plastic.

11. The wrapper of claim 1, and use instructions printed on an outer surface of the outer layer.

12. A method of handling food, comprising the steps of:
a) overlapping inner and outer layers of sheet materials to bound a compartment;
b) inserting a food into the compartment;
c) wrapping the layers from an unwrapped state to a wrapped state in which the layers form an envelope surrounding the food;
d) weakening a zone in the layers and dividing the envelope into envelope portions;
e) removing one of the envelope portions from the other of the envelope portions along the zone to expose the food in the wrapped state; and
f) sealing the layers in the other of the envelope portions to resist food escape therefrom.

13. The method of claim 12, wherein the wrapping step is performed by rolling the layers about a rolling axis.

14. The method of claim 12, wherein the weakening step is performed by scoring the layers.

15. The method of claim 12, wherein the removing step is performed by tearing the envelope along the zone in a single manual stroke.

16. The method of claim 12, and printing use instructions on an outer surface of the outer layer.
